(19) United States
(12) Patent Application Publication
(10) Pub. No.: US 2007/0267253 A1
(43) Pub. Date: Nov. 22, 2007

(54) METHOD AND APPARATUS FOR RECORDING BOOKS

(76) Inventor: Ryan Tauer, St. Paul, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/744,435

(22) Filed: May 4, 2007

Related U.S. Application Data
(60) Provisional application No. 60/746,415, filed on May 4, 2006.

(51) Int. Cl. B65G 47/00

(52) U.S. Cl. 186/35

(57) ABSTRACT

Disclosed is an apparatus and method for recording a literary work. An apparatus for recording a literary work can include a booth and a recording system. The recording system can include a display screen, a microphone and a CPU. A user can interact with the recording system to record a literary work. In one method, the user can activate the recording system and the recording system can prompt the user to enter information, for example information about the user and about the literary work that the user wishes to read. The user can then read the literary work and the recording system can make an audio or video recording of the reading.

This application claims the benefit of U.S. Provisional Application No. 60/746,415, entitled “METHOD AND APPARATUS FOR RECORDING BOOKS,” filed May 4, 2006, the entirety of which is herein incorporated by reference.

### TECHNICAL FIELD

The technical field pertains generally to recording the voice and/or image of a person reading a literary work.

### BACKGROUND

The publishing industry uses a wide variety of methods for marketing and selling literary works. Customers commonly purchase books from a store, for example, a traditional store or an online store. Customers can purchase literary works in many different formats, including hard copy, electronic format or in a books-on-tape format. There is an ongoing need for other methods and formats in which to market and sell literary works.

### SUMMARY OF SOME EMBODIMENTS

An example embodiment can be found in a booth. The booth can be placed in a retail store that sells books. The booth can have a door on it which can be closed in order to create a substantially sound-proof enclosure. The inside of the booth can have a bench or other object on which a user can be seated. The booth can also have a shelf or desk surface. The shelf or desk can have a computer screen placed on or near it, along with a microphone. A computer processor can be placed under the shelf or desk or it can be placed in a cabinet inside or outside the booth. The computer screen can be a touch screen that allows for user interaction or another user interface can be provided, for example a keyboard or a mouse, or both types of user interfaces can be provided. The computer, its peripheral equipment and the screen can collectively be referred to as the recording system. At least a portion of the outsides of the booth can have book shelves on it. For example, book shelves can be placed on the side(s) of the booth and/or a portion of the front of the booth.

In another example embodiment, a method of recording a literary work can include a user entering a booth. The user can, for example, choose a book and bring the book into the booth. Once in the booth, the user can interact with the recording system to record the user's voice and/or image reading the book. In some embodiments, the recording system can provide prompts to help the user make the recording. The recording system can then prompt the user to enter information, for example to whom the user wants to give the literary work, the name of the user, and the title of the literary work. The user can enter this information through a touch screen and/or a keyboard and/or other interactive devices. The recording system can also prompt the user to begin reading. The user can read all or a section of the literary work. In the case where the user reads a section of the literary work, the recording system can insert into the recording an audio or visual cue indicating the end of the section, for example a page or chapter. The recording system can then prompt the user to continue reading the next section. Once the user has read all (or the desired portion) of the literary work, the user can choose a prompt that indicates as such. The recording system can produce an audio or video file of the recording and, in some cases, can produce a copy of the recording on a removable recording media such as a compact disk (CD).

The above summary of some embodiments is not intended to describe each disclosed embodiment or every implementation of the present invention. The Figures, and Detailed Description which follows, more particularly exemplify these and other embodiments.

### BRIEF DESCRIPTION OF THE FIGURES

FIG. 1 is an overhead view of an embodiment of a booth;

FIG. 2 is a view of the front of the booth of FIG. 1;

FIG. 3 is flow diagram for a method of producing a recording of a person reading a literary work;

FIG. 4 is a flow diagram for an alternate method of producing a recording of a person reading a literary work; and

FIG. 5 is a flow diagram for a sample step-by-step method for a recording system.

### DETAILED DESCRIPTION OF SOME EMBODIMENTS

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

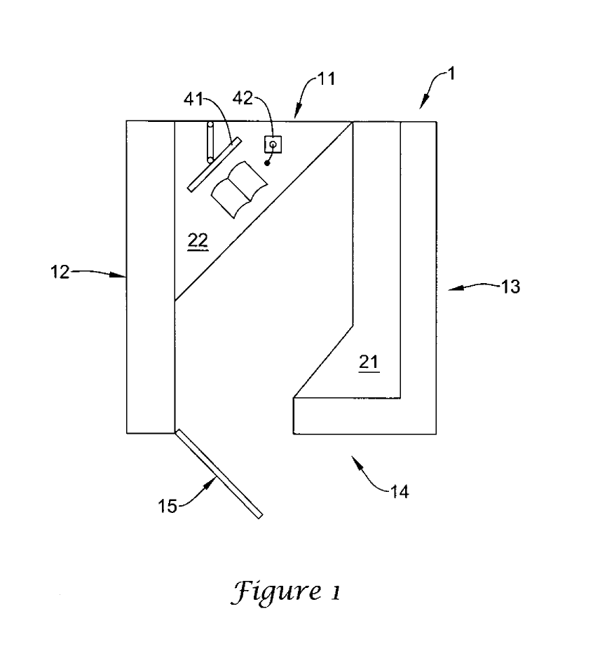

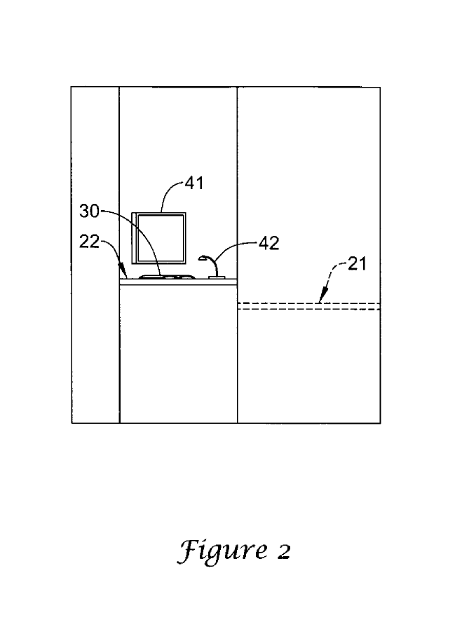

Turning to FIG. 1, an overhead view of a booth 1 is shown. The booth 1 can have four walls (11, 12, 13, 14). In some embodiments, a back wall 11 can be placed against a wall of a building, or the back wall 11 can be a wall of a building. The two side walls (12, 13) can have shelves on them, for example book shelves. The booth front wall 14 can have a door 15, which can be sized for a person to enter the booth 1. As shown in FIGS. 1 and 2, the width of the door 15 can be less than the width of the front wall of the booth 1. Alternatively, the door 15 can be the entire of the booth front wall 14, allowing the entire front of the booth 1 to be opened. The door 15 could also comprise a double set of doors.

In some cases, the width of the door 15 can be less than the width of the front wall 14, and the remainder of the booth front wall 14 can comprise a book shelf. In some embodiments, the booth 1 can be a stand-alone structure, in which case all of the wall surfaces except for the door can comprise shelves. In other cases, the booth 1 can be against one, two or three walls or other structures within a building, for example within a store that sells books. For example, the back wall 11 in FIG. 1 can be placed against a wall or other structure of a building. In a further example, the booth 1 can be set into a wall or other structure of a building so that most or all of the side walls (12, 13) are hidden from view. The booth walls that are against the walls or structures of the building or are set into a wall or other structure could be without shelves.

Referring to both FIGS. 1 and 2, the booth 1 can have a place for a user to be seated, for example a bench 21. The bench 21 can be at a typical chair height or at a typical stool height, or any other suitable height. Further, the booth 1 can have a shelf or desk 22. The shelf or desk 22 can be a surface on which to place a book 30 or any other items a user may wish to set down in the booth 1. The booth 1 can also have a computer screen 41 and a microphone 42. Both the computer screen 41 and the microphone 42 can be attached to a CPU (not shown). The CPU can be placed in a cabinet inside or outside the booth 1, or the CPU can be a stand-alone computer placed inside or outside the booth 1, or in other cases the CPU can be contained within the structure of the booth or the other hardware. The CPU, the screen 41 and the microphone 42 and any other peripheral equipment can collectively be referred to as a recording system. In alternative embodiments, the recording system can be any system that is configured to receive audio and/or video signals and record the signals.

The screen 41 can be a touch screen, allowing a user to control the recording system by touching prompts on the screen 41. As an alternative to, or in addition to, a touch screen, other interface devices such as a keyboard, mouse, video camera, still-picture camera, speakers, headset, etc can be included in the recording system. For example, a headset and/or one or more speakers can be included so that the user can listen to all or a portion of the recorded file. In another example, a video camera can be included in order to record the image of a user reading a literary work. In yet another example, a still-picture camera can be included in order to record one or more still images of a user before, during or after reading a literary work.

Also, the recording system can have a recording medium on which to record the audio or video data, for example a computer hard drive. In some cases, the recording system can also have an apparatus for transferring the recorded file onto a removable recording media, for example a compact disk, a flash memory device (e.g., an MP3 player, an iPod™ or a cellular phone, or a flash memory storage drive), or an apparatus with a portable hard drive (e.g., an iPod™), or other such devices. In addition to, or instead of, the apparatus for transferring the recorded audio or video file onto a removable recording media, the recording system can be electronically connected to a remote location and/or connected to another device within the same retail location. For example, a file could be sent to a file transfer device at the check-out of a retail location, and the file transfer device can be used to transfer the file to a removable recording media. The recording system could also send the file to a remote location, for example via the Internet or an intranet, and the file could be transferred to a removable recording media from that location. In any case, storage capacity for the recorded files can be provided in the recording system and/or in a device with which the recording system communicates and/or at a remote location, and the file can be stored there for a predetermined or indefinite period of time.

In some embodiments, the recording system can also have a storage system for storing electronic copies of literary works. Electronic copies of literary works could also be electronically stored at a remote device or location and the recording system could download the electronic version of the literary work. An electronic version of the literary work could be presented to a user on screen 41. For example, the screen 41 could have the capability to provide split viewing of the literary work on portion of the screen and of other interactive features on another portion of the screen.

Further, it is contemplated that the term “booth” can encompass any combination of the above elements described with respect to FIGS. 1 and 2. For example, a booth could have a structure on which a user can sit and a recording system, but can be substantially or entirely open, for example with walls on only 3 sides, only 2 sides, on one side, or have no walls, or the confines of the booth can be delineated in some other fashion. Further, the walls can be rigid, or they can be made of another material such as a cloth-like or curtain-like material.

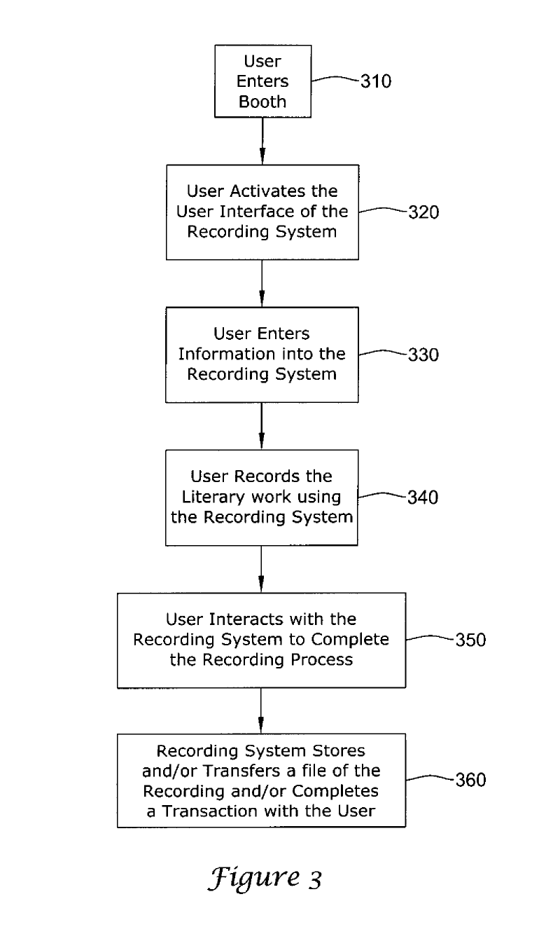

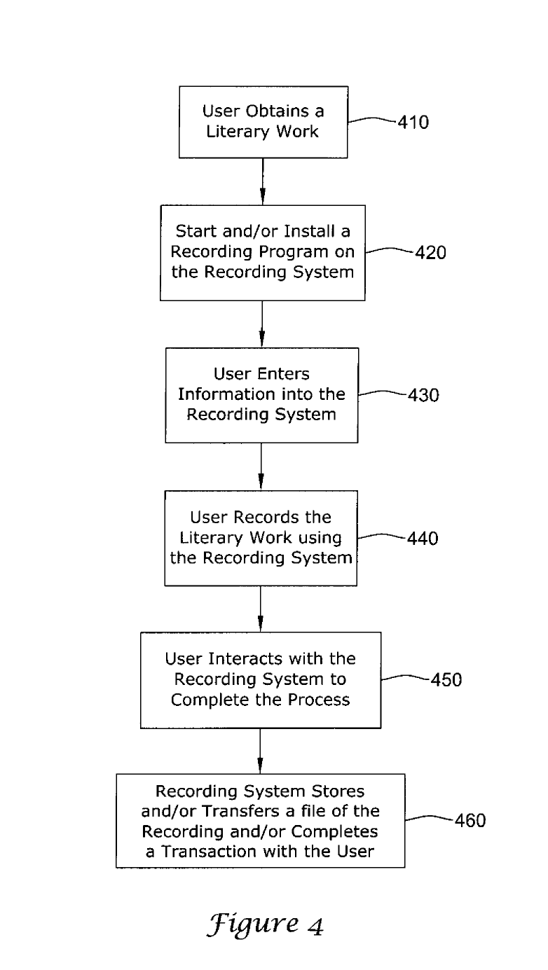

In another embodiment, the invention includes a method for recording a literary work, for example making an audio or video recording. Referring to FIG. 3, a process flow diagram of one example method is shown. In step 310, the user can enter a booth, for example any of the booths described herein. The user can have a hard copy of a book, or the user could view an electronic version of the book, or the user could both have a hard copy of the book and intend to view an electronic version of the book. If the user views an electronic copy of the book, the system can allow the user to view the book on the screen, for example in a scanned in format or in some other graphical type format, for example in steps 340 of FIG. 3 or 440 of FIG. 4, described below. In these steps, the recording system can display the book on one portion of the screen and other interactive features on another portion of the screen.

In step 320, the user can activate the recording system interface. This can be done by turning on a power button, by touching a touch screen, by using an interactive device such as a keyboard or mouse, by any combination of these methods, or in any other suitable manner. In step 330, the user can be prompted to enter information into the recording system. For example, the recording system can have blank text boxes in which the user can enter information. In addition, some information can be entered by choosing from options, for example from drop-down menus. The information that can be entered can be, for example, the name of the user, the name of the person being read to, the date, the time, the location, a text message, whether the user wants to have cues for the section breaks entered or not, or any other type of information.

Information about the transaction can also be entered at this screen, for example the type of finished file that is desired (e.g., the file format), the number of copies desired, the payment information, and other information about the form of the transaction. The user can also be asked at this step to confirm that they plan to purchase a copy of the literary work. Any of this information, for example any of the information about the transaction, can also be entered at other points in the process. For example, some of the transaction information can be entered at step 350, described below. Some of the information could also be entered into the same or a different system, or communicated orally to a salesperson, for example in step 360, which is further described below.

In step 340, the user can record a user reading the literary work, and in step 350, the user can interact with the recording system to indicate that they have completed the reading. As shown at step 360, a transaction such as a purchase can also occur. The user can enter payment information (e.g., credit card information) in the recording system, the user can pay for the service at a check-out desk, or other forms of payment can be used.

Further, in step 360, the recording system can prepare the file or the recording for the user. For example, the recording system can format the file in a specified file format. Further, the recording system can place the file on a removable storage media, for example the system could allow the user to download the file onto a device containing flash media or another type of portable disk drive, or the system could place the file on another type of removable media, for example a DVD or CD.

In step 360, the recording system can also send the file to another device or to a remote location. In some embodiments, the file can be sent to another device within the same retail location, for example at the check-out. The device at the check-out counter can receive the file and allow the file to be downloaded onto a device containing flash media or another type of portable disk drive, or the device could place the file on another type of removable media, for example a DVD or CD. Further, if the system sends the file to a remote location, a device at the remote location can receive the file and allow the file to be downloaded onto a device containing flash media or another type of portable disk drive, or the device could place the file on another type of portable disk drive, for example a DVD or CD. If the recording is sent to a remote location and placed on a removable storage media, the removable storage media can then be sent to the user, for example through the mail. The removable storage media could also be sent to a third party, for example to the person that the recording is being made for (or to a third person's caregiver), or to multiple people and/or locations.

In addition, the file could also be stored at the booth and/or in another device and/or at a remote location. The file can be retained for a certain period of time and then discarded or it can be retained for an indefinite period of time. As another example, the file can be sent electronically to the user or to a third party, or to multiple people and/or locations. The file can be sent electronically in addition to, or instead of, producing the file on a removable storage media. If an electronic file is sent to the user or to a third party, a message can be included with the file (for example, the message can be in or attached to an e-mail). A person that receives an electronic copy of the recording can transfer the recording to another person, can open the file on their own computer, or can transfer the file to a removable storage media. The message can comprise a standard message and/or color and/or graphics scheme, and can also include custom text or images. The standard formats for the message and/or the custom text can be entered, for example in step 330 or step 360. Custom pictures or other graphics can also be downloaded onto the recording system by the user, allowing the user to choose to use custom pictures or graphics in the electronic message.

Also, in step 360, the recording system, another device, or a device at a remote location can produce media materials to accompany the file. For example, the recording system another device could have a mechanism for creating a standard or custom greeting card to send, for example in electronic or hard copy form, to a third party. In such a case, the user can choose to use standard information, photographs, color schemes, graphics, etc, or the user can download to the recording system custom data to use in the media materials. In embodiments where the system produces a file on a removable storage media (e.g., a CD), the system can also print a label for the removable storage media and/or the system can print a message or other images directly on the removable storage media.

The recording system can have one or more ports or disk drives for removable media so that a user can download custom graphics or photographs to the system. These graphics or photographs can be used, for example, in an e-mail message or in other media materials, as mentioned above.

Turning now to FIG. 4, an alternate method for making a recording of a literary work is shown. In this example method, a user can make a recording on a recording system that is not within a retail store. As an example, the user can make a recording on his or her own computer or on a computer at any desirable location. In the context of this application, a recording system can include a personal computer or other system that a user can utilize to make a recording. Such a recording system can have any or all of the elements of the other recording systems described herein.

In step 410, the user can obtain a literary work. For example, the user could get a hard copy of a book at a book store, the user could order a hard copy of the book through an online vendor, or the user could obtain an electronic copy of the literary work, for example through an online merchant.

In step 420, the user can start a recording program on a recording system. As an example, if the user obtained a hard copy of the literary work, the hard copy could come with a program that can be installed on the recording system (e.g., a CD with a program on it). As another option, the user can download the program onto the recording system. In this example, the user can purchase the program online, or the user can be required to have an access code or some other proof that the user has a right to download and use the program. For example, an access code could be provided with the purchase of the literary work. As yet another option, the program could be a web based program, which for the purposes of this application is defined as a program that has all or a portion of the program residing on a remote device (e.g., a server), and the recording system interacts with the remote device in order to perform the operations of the program. For example, the recording system can interact with the remote device through a web browser. In the case where the program is located on a remote device, the remote device can be considered part of the recording system.

In steps 430, 440 and 450, the user can interact with the recording system in order to enter information into the system and record the reading of the literary work. Steps 430, 440 and 450 can be the same as or similar to steps 330, 340 and 350, with respect to FIG. 3. In step 460, the process can be completed. As an example, any of the ways in which the process was completed in step 360 of FIG. 3 can be used.

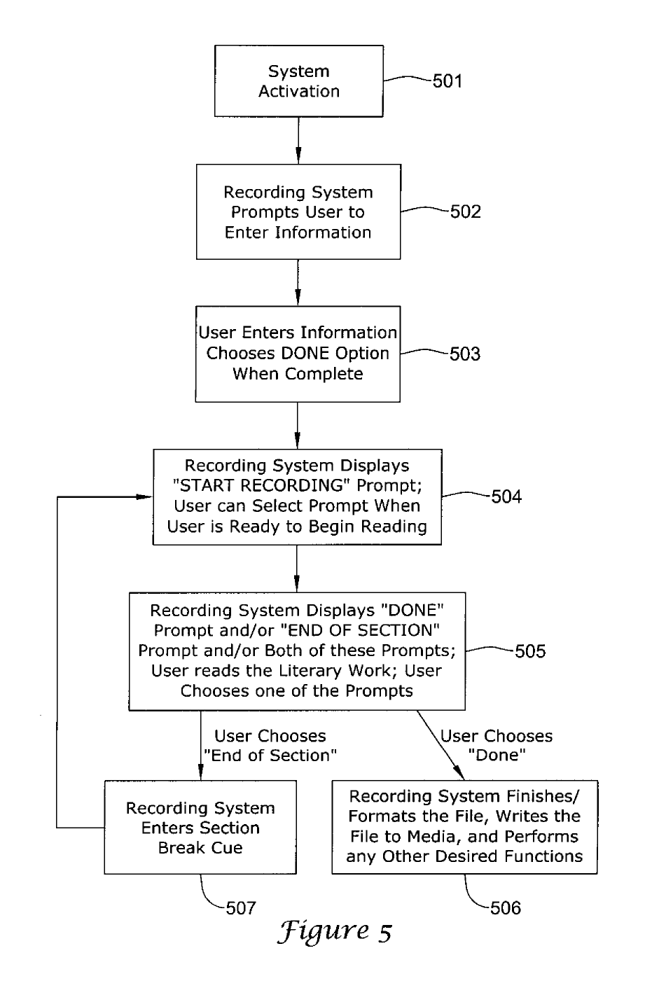

In both FIGS. 4 and 5, the recording system can also enable the user to record an introduction or closing statement for the reading, or a statement that can be placed at an intermediate point in the reading. The recording system could prompt the user to record one or more of these messages at a separate step in the process, or it could prompt the user to do so in steps 330 or 430.

Turning now to FIG. 5, an example process diagram for a recording system is shown. As an example, the process depicted in FIG. 5 can be the process that the recording system uses in order to facilitate the processes shown in FIGS. 3 and 4.

In step 501, the recording system can be activated. As mentioned above, this can be done by turning on the system, touching a touch screen, using an interactive device (keyboard, etc), or by other suitable methods. Further, the recording system can display a START option. The START option can have any suitable appearance and can use language other than the word “start,” for example the words “begin” or “next” may also be used.

In step 502, the recording system can prompt the user to enter specified information, and in step 503 the user can enter the information. As mentioned above, a variety of information can be entered for a variety of purposes. Some of the information can be entered as text (for example, by choosing characters on a touch screen or by using a keyboard or mouse), and some of the information can be chosen from options provided by the recording system, for example as pull down menus. The recording system can also display a DONE option, The DONE option can have any suitable appearance; for example, it can use words such as “next” and “finished” rather than the word “done.” Choosing the DONE option can send the recording system on to the next step.

Further, after step 503, an optional confirmation step can be shown to the user so that the user can confirm some or all of the choices and entries that were made in step 503. If the user detects an error, a prompt can be chosen that will send the recording system back to step 502. If the user does not detect an error, a prompt can be chosen that sends the recording system on to step 504.

In step 504, the recording system can display a START RECORDING option. When the user chooses this option, the recording system can proceed to step 505 and start recording, and the user can begin reading. In step 505, the recording system can display additional options for the user while the user is reading. For example, one option can be a DONE option (which, as mentioned above, can incorporate words other than “done” and can have any appropriate appearance). Another option can be an END OF SECTION option. This option can incorporate other words or phrases such as “end of page” or “end of chapter.” The user can choose this option when they are at the end of a section, for example a page or chapter. If the DONE option is chosen, the recording system can advance to step 506. In this step, the recording system can finish the process, for example by performing any combination of the steps that were described with respect to steps 360 or 460.

If the END OF SECTION option is chosen, the recording system can proceed to step 507, where a cue can be placed in the recording to alert someone that is listening to the recording that the end of the section, for example the page or chapter, has been reached. Examples of suitable cues could be a sound, a standard short statement that the recording system has stored, or a custom sound or statement that the user could record or download into the recording system, for example during step 503. The system can then return to step 504, and the next section could be recorded. Alternatively, the system could return to step 505 and the system could immediately being recording.

Further, after choosing either the DONE or END OF SECTION options in step 505, the recording system can inquire whether the user wishes to listen to all or a portion of the recording. If the user chooses to listen to all or a portion of the recording, the recording system can play the recording back to the user. Further, the recording system can also give the user the option to discard all or a portion of the recording. For example, the user can be given the option to delete all or a portion of the recording before, after, or during listening to all or a portion of the recording. If the user chooses to delete all or a portion of the recording, the recording system can also display a confirmation message in order to have the user confirm the deletion of the material.

The method of FIG. 5 can also include other steps or features. For example, the recording system can have a tutorial, such as an optional tutorial that can be presented at or near the beginning of the process. The recording system can also display a HELP option, or other similar option, throughout the process. If a user chooses the HELP option, the recording system can send the user to the tutorial or to a separate help screen, and, when done with the tutorial or help screen, the recording system can return the user back to the step in the process where the user left off. The tutorial or help screen can simply be lists of frequently asked questions (with the corresponding answers), it can be a series of screens with explanations of the step being displayed on the screen, or it could be any other suitable tutorial.

The recording system can also display a stop and/or pause and/or exit and/or escape option throughout most or all of the process. These options can allow the user to exit the process entirely and/or pause the process and return to that point in the process at a later time.

Further, in the case where a recording is being made in sections (e.g., each section is being read and is being separated by a cue, as described above), the recording system can display the section that is currently being recorded.

The recording system can also include a system for enhancing or otherwise manipulating the audio or video recording. Enhancement features can be automatically performed by the recording system, or the user can choose to use certain enhancement features. As one example, a background sound can be placed in the recording, or in video recordings a background scene or picture can be placed in the recording. Other enhancement features can include removing background noise or other features to make the audio and/or video clearer.

Also, an optional feature of the system can be to pre-program certain literary works or certain features that are tailored to certain literary works into the system, and thus make it impossible or inconvenient to use the recording system to record other literary works. For example, a certain number of section breaks or other features that are tailored to certain works can be programmed into the recording system.

As noted above, all or a portion of the methods can be performed by one device, or the methods can be performed collectively by the more than one devices, for example if the recording system comprises more than one device. Further, a program comprising computer code can be made to implement any of the above steps. The computer code can be stored on any of the devices discussed in this application. As an alternative, the computer code can be stored on a removable storage medium. In addition, the computer code can be stored and/or implemented partially on one device or removable storage medium and partially on another device or removable storage medium.

We claim:

1. A retail store having literary works for sale, the store having a booth, the booth comprising:
a recording device adapted to make a recording of a literary work, the recording device comprising:
a receiving device adapted to receive audio communications from a user, the audio communications comprising the user reading aloud a literary work;
a display adapted to communicate information to the user; and
a user interface adapted to receive inputs from the user.

2. The store of claim 1 wherein the recording device is adapted to:
prompt the user to enter information pertaining to the audio communications;
receive the information pertaining to the audio communications;
prompt the user to begin reading the literary work; and
receive audio communications from the user.

3. The store of claim 1, wherein the receiving device is an audio receiving device comprising a microphone.

4. The store of claim 1, wherein the display is a monitor.

5. The store of claim 1, wherein the user interface is selected from a group consisting of a computer mouse, a keyboard, a computer mouse with a keyboard, and a touch screen.

6. The store of claim 1, the recording device further comprising a transfer device, the transfer device adapted to transfer at least a portion of the audio communications to a removable storage media.

7. The store of claim 6, wherein the transfer device is a CD burner.

8. The store of claim 6, wherein the transfer device is disposed within or on the booth.

9. The store of claim 6, wherein the transfer device is disposed at a check-out location within the store.

10. The store of claim 1, wherein the recording system further comprises a storage system, the storage system being adapted to store the received audio communications.

11. The store of claim 1, wherein the recording device further comprises a remote storage system, the remote storage system being adapted to store the received audio communications.

12. The store of claim 11, wherein the remote storage system is located outside of the store.

13. The store of claim 1, further comprising a playback device adapted to play back at least a portion of the audio communications.

14. The store of claim 13 wherein the playback device is selected from a group consisting of a headset and one or more speakers.

15. The store of claim 1 wherein the recording device further comprises a video receiving device adapted to receive a video image of the user.

16. The store of claim 15, wherein the recording system further comprises a storage system, the storage system being adapted to store both the received audio communications and the received video image.

17. The store of claim 15, wherein the recording device further comprises a remote storage system, the remote storage system being adapted to store both the received audio communications and the received video image.

18. The store of claim 17, wherein the remote storage system is located outside of the store.

19. The store of claim 1 wherein the booth is an enclosure located within the store.

20. The store of claim 1 wherein the booth comprises an enclosure that has a door, the door having an open and a closed configuration, wherein the enclosure is substantially sound proof when the door is in the closed configuration.

21. A method for recording a literary work comprising the steps of:
providing a selection of literary works;
providing a recording system, the recording system comprising:
a receiving device adapted to receive audio communications from a user,
the audio communications comprising the user reading aloud a literary work;
a display adapted to communicate information to the user; and
a user interface adapted to receive inputs from the user
receiving the audio communications from the user;
transferring at least a portion of the audio communications from the recording device; and
collecting a fee from the user.

22. The method of claim 21 wherein collecting a fee from the user comprises selling both the recording and the literary work to the user for a fee.

23. The method of claim 21 wherein collecting a fee from the user is performed at a location other than the location at which the recording system is provided.

24. The method of claim 21, wherein the recording system is adapted to prompt the user for information pertaining to the audio communications and wherein the user interface is adapted to receive the information from the user, the method further comprising the steps of prompting the user for the information and receiving the information from the user.

25. The method of claim 24 wherein the information is selected from the group consisting of information about the user, information about the literary work, information about a person to whom a recording is going to be given, and any combination of these types of information.

26. The method of claim 25 further comprising the step of using the information to determine the number of sections in the literary work and provide a number of prompts to the user based on the number of sections.

27. The method of claim 21 wherein the recording system is adapted to prompt the user for an opening message, a closing message or both an opening and closing message and wherein the user interface is adapted to receive the message or messages from the user, the method further comprising the steps of prompting the user for the opening and/or closing messages and receiving the opening and/or closing messages from the user.

28. The method of claim 21, wherein the user interface is selected from a group consisting of a keyboard, a mouse and a touch screen.

29. The method of claim 21, wherein the receiving device is a microphone.

30. The method of claim 21, wherein the selection of literary works and the recording system are provided in a retail store.

31. The method of claim 21 wherein the recording system is provided in a booth, the booth and selection of literary works being provided in a retail store.

32. The method of claim 21, wherein the step of transferring at least a portion of the audio communications from the recording device comprises the step of transferring at least a portion of the audio communications to a removable storage media.

33. The method of claim 32, wherein the step of transferring at least a portion of the audio communications to a removable storage media is performed at a location other than the location at which the recording device is provided.

34. The method of claim 33, wherein the step of transferring at least a portion of the audio communications to a removable storage media is performed at a check-out at a retail store.

35. The method of claim 21, wherein the selection of literary works comprises a selection of one or more physical books.

36. The method of claim 21, wherein the selection of literary works comprises a selection of one or more electronic books.

37. The method of claim 36 wherein the recording device is adapted to display the one or more electronic books.

38. The method of claim 21 wherein the recording system is adapted to play back at least a portion of the audio communications and wherein the recording system is adapted to allow the user to delete at least a portion of the audio communications, the method further comprising the steps of playing back at least a portion of the audio communications and presenting the user with an option to delete at least a portion of the audio communications, deleting the at least a portion of the audio communications if the user elects to delete the at least a portion of the audio communications, and prompting the user to re-read the at least a portion of the audio communications.

39. A computer readable medium having computer executable instructions for performing a method comprising:
prompting a user for information pertaining to a literary work;
receiving the information from the user;
prompting the user to provide an audio communication of the literary work;
receiving audio communications from the user; and
transferring the received audio communications.

40. The computer readable medium of claim 39 wherein the method further comprises the step of collecting a payment from the user.

41. An electromagnetic signal carrying computer-readable instructions for recording an audio communication of a literary work, where the instructions comprise the steps of:
prompting a user for information pertaining to a literary work;
receiving the information from the user;
prompting the user to provide an audio communication of the literary work;
receiving audio communications from the user; and
transferring the received audio communications.

42. The computer readable medium of claim 41 wherein the method further comprises the step of collecting a payment from the user.

43. A retail store having literary works for sale, the store having a booth, the booth comprising:
a recording device adapted to make a recording of a literary work, the recording device comprising:
a receiving device adapted to receive audio communications from a user,
the audio communications comprising the user reading aloud a literary work;
a display adapted to communicate information to the user;
a user interface adapted to receive inputs from the user;
a transfer device, the transfer device adapted to transfer at least a portion of the audio communications to a removable storage media; and
a playback device adapted to play back at least a portion of the audio communications;
wherein the recording device is adapted to:
prompt the user to enter information pertaining to the audio communications;
receive the information pertaining to the audio communications;
prompt the user to begin reading the literary work; and
receive audio communications from the user;
wherein the booth is an enclosure within the store.

44. A method for recording a literary work comprising the steps of:
providing a selection of literary works;
providing a recording system, the recording system comprising:
a receiving device adapted to receive audio communications from a user,
the audio communications comprising the user reading aloud a literary work;
a display adapted to communicate information to the user; and
a user interface adapted to receive inputs from the user receiving the audio communications from the user;
transferring at least a portion of the audio communications from the recording device; and
collecting a fee from the user;
wherein collecting a fee from the user comprises selling both the recording and the literary work to the user for a fee;
wherein the recording system is adapted to prompt the user for information pertaining to the audio communications and wherein the user interface is adapted to receive the information from the user, the method further comprising the steps of prompting the user for the information and receiving the information from the user;
wherein the recording system is provided in a booth, the booth and selection of literary works being provided in a retail store; and
wherein the step of transferring at least a portion of the audio communications from the recording device comprises the step of transferring at least a portion of the audio communications to a removable storage media.
